(19) United States
(12) Patent Application Publication
(10) Pub. No.: US 2009/0268718 A1
(43) Pub. Date: Oct. 29, 2009

(54) COMMUNICATION METHOD AND SYSTEM OF INTERNET

(75) Inventors: Wan-Jiun Liao, Taipei City (TW); Jie-Min Chen, Taipei City (TW); Jeng-Farn Lee, Sindian City (TW); Yi-Chang Chang, Yuanlin (TW); Chih-Hsiang Yeh, Taipei City (TW)

Correspondence Address: RABIN & Berdo, PC, 1101 14TH STREET, NW, SUITE 500, WASHINGTON, DC, 20005, US

(73) Assignees: Quanta Computer Inc., Tao Yuan Shien (TW); Natioanl Taiwan University, Taipei (TW)

(21) Appl. No.: 12/359,238

(22) Filed: Jan. 23, 2009

(30) Foreign Application Priority Data
Apr. 29, 2008 (TW) 97115785

(51) Int. Cl. H04L 12/66

(52) U.S. Cl. 370/352

(57) ABSTRACT

An Internet communication system including a first access point, a second access point, a first caller and a first callee is provided. The first access point and the second access point are respectively located in a first LAN and a second LAN. The first caller, having a probing-based mechanism, accesses the Internet via the first access point and has voice packets with a first transmission priority. The first callee accesses the Internet via the second access point. The first caller transmits a simulation packet to the first callee for probing a transmission quality of an end-to-end transmission path of the first caller and the first callee to determine whether to invite the first callee to communicate via the Internet.

This application claims the benefit of Taiwan application Serial No. 97115785, filed Apr. 29, 2008, the subject matter of which is incorporated herein by reference.

### BACKGROUND OF THE INVENTION

1. Field of the Invention

The invention relates in general to an Internet communication method and system, and more particularly to an Internet communication method and system capable of assuring the quality of service (QoS).

2. Description of the Related Art

Voice over Internet Protocol (VoIP) converts audio data to digital signals through the audio service provided by the Internet, and executes real-time end-to-end communication via the Internet by way of voice packets. VoIP has the advantages of integration, globalization, real-time and mobility. Furthermore, VoIP can communicate with the conventional public switched telephone network (PSTN) and has become a mainstream protocol in global communication.

However, under the distributed environment of IEEE 802.11 wireless local area network (LAN), the transmission of the voice packets of VoIP via access points (AP) may likely be affected by the transmission of packets of other types or too many admitted VoIP users, hence the network being congested or unstable. Thus, the real-time property of the VoIP cannot be satisfied, and the quality of service (QoS) of VoIP will be too low.

### SUMMARY OF THE INVENTION

The invention is directed to an Internet communication method and system. As the voice packets are set to have a first transmission priority, and the call admission control (CAC) mechanism is determined according to the transmission quality of an end-to-end transmission path which is monitored in real time, the quality of service (QoS) of Internet communication is assured.

According to a first aspect of the present invention, an Internet communication method applied to a first caller and a first callee is provided. The first caller is located in a first LAN and accesses the Internet via a first access point. The first callee is located in the second LAN and accesses the Internet via a second access point. The Internet communication method includes the following steps. The first caller and the first access point are set, such that the voice packets of the first caller have a first transmission priority. The first caller, via the Internet, queries the QoS server end regarding whether the network communication quality of the first LAN and the second LAN is above a pre-determined quality. If the network communication quality of the first LAN and the second LAN is above the pre-determined quality, the first caller transmits a simulation packet to the first callee for probing a transmission quality of an end-to-end transmission path of the first caller and the first callee. Whether a corresponding QoS parameter is larger than a threshold value is determined according to the transmission quality. If the QoS parameter is larger than the threshold value, the first caller invites the first callee to communicate via the Internet.

According to a second aspect of the present invention, an Internet communication system including a first access point, a second access point, a first caller and a first callee is provided. The first access point and the second access point are respectively located in a first LAN and a second LAN. The first caller, having a probing-based mechanism, accesses the Internet via the first access point and has voice packets with a first transmission priority. The first callee accesses the Internet via the second access point. The first caller transmits a simulation packet to the first callee for probing a transmission quality of an end-to-end transmission path of the first caller and the first callee to determine whether to invite the first callee to communicate via the Internet.

The invention will become apparent from the following detailed description of the preferred but non-limiting embodiments. The following description is made with reference to the accompanying drawings.

### BRIEF DESCRIPTION OF THE DRAWINGS

FIG. 1 shows an Internet communication system according to a preferred embodiment of the invention; and

FIG. 2A and FIG. 2B show the process of an Internet communication method according to a preferred embodiment of the invention.

### DETAILED DESCRIPTION OF THE INVENTION

The invention provides an Internet communication method and system. As voice packets are set to have a first transmission priority, the transmission of voice packets will not be affected by packets of other types, and the call admission control (CAC) mechanism is determined according to the transmission quality of an end-to-end transmission path which is monitored in real time, such that the number of LAN users is restricted, and the quality of service (QoS) of Internet communication is assured.

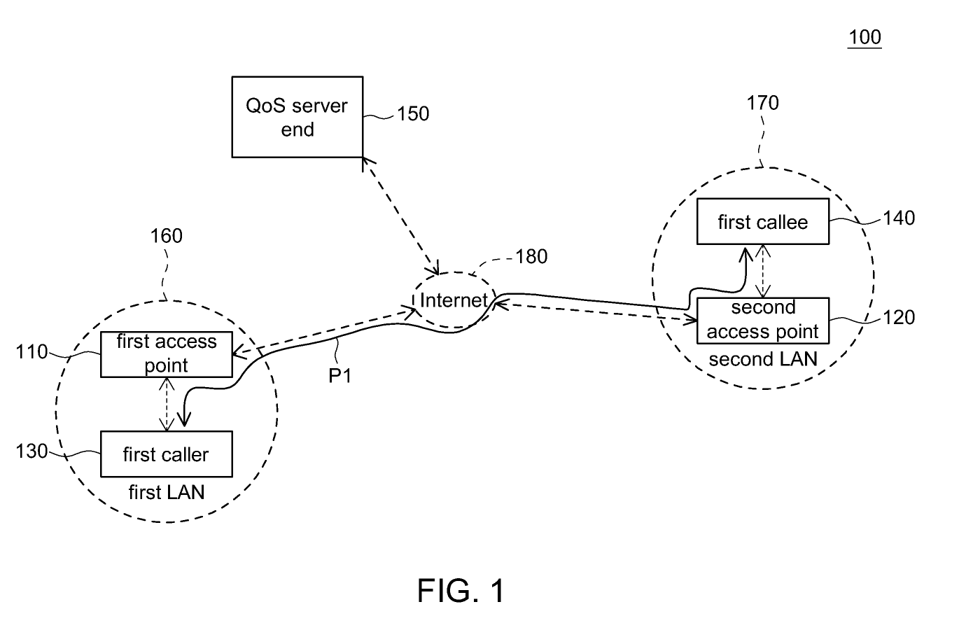

Referring to FIG. 1, an Internet communication system according to a preferred embodiment of the invention is shown. The Internet communication system 100 includes a first access point (AP) 110, a second access point 120, a first caller 130, a first callee 140 and a QoS server end 150. The first access point 110 and the second access point 120 are respectively located in a first LAN 160 and a second LAN 170, wherein the first LAN 160 is a wireless LAN for example.

The first caller 130, located in the first LAN 160, accesses the Internet 180 via the first access point 110 and has voice packets with a first transmission priority. The first caller 130 is a probing-based VoIP for example. The first callee 140 is located in the second LAN 170 and accesses the Internet 180 via the second access point 120. The QoS server end 150 is connected to the Internet 180 and is located in remote-end LAN or the first LAN 160, but the invention is not limited thereto.

The first caller 130, via the Internet 180, queries the QoS server end 150 regarding whether the network communication quality of the first LAN 160 and the second LAN 170 is above a pre-determined quality. If the network communication quality of the first LAN 160 and the second LAN 170 is above the pre-determined quality, the first caller 130 transmits a simulation packet to the first callee 140 for probing a transmission quality of an end-to-end transmission path P1 of the first caller 130 and the first callee 140 to determine whether to invite the first callee 140 to communicate via the Internet 180. The simulation packet is identical to the voice packet.

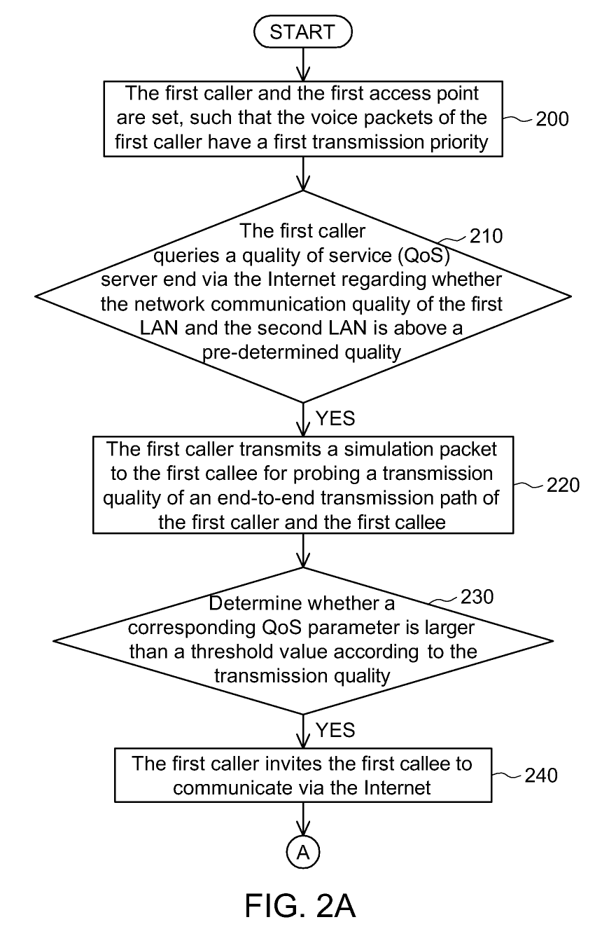

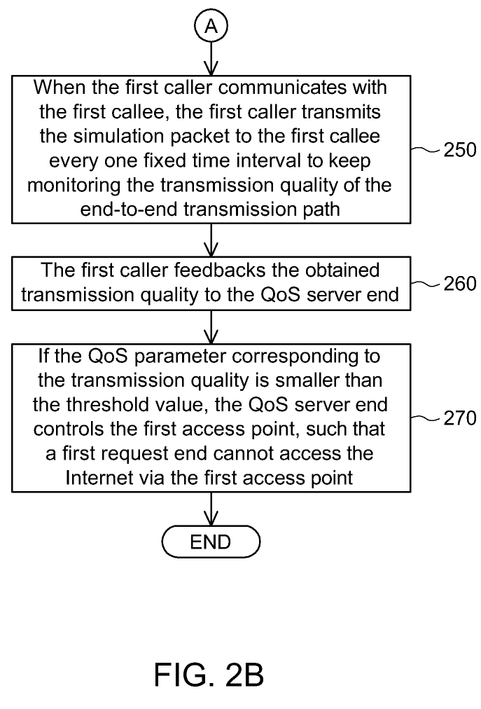

Referring to FIG. 2A and FIG. 2B, the process of an Internet communication method according to a preferred embodiment of the invention is shown. Firstly, the method begins at step 200, the first caller 130 and the first access point 130 are set, such that the first caller 130 has voice packets with a first transmission priority. In step 200, the media access control (MAC) layer of the first caller 130 is set in conformity to IEEE 802.11 protocol. For example, the contention window of the first caller 130 is set as follows: CWmin[ACᵢ]>=AIFS[ACᵢ₊₁]+CWmax[ACᵢ₊₁], wherein i is a category of access type.

Thus, packets of other types will not be transmitted before the voice packets of the first caller 130 are all transmitted. The voice packets have the first transmission priority with respect to the first caller 130. Then, when the first caller 130 would like to access the Internet 180 via the first access point 110, the first caller 130 will substantially set the network management interface of the first access point 110 automatically via a back-end program, such that the voice packets also have the first transmission priority with respect to the first access point 110.

In step 210, the first caller 130, via the Internet 180, queries the QoS server end 150 regarding whether the network communication quality of the first LAN 160 and the second LAN 170 is above a pre-determined quality. The QoS server end 150 can be an application software or a hardware server. The QoS server end 150 used for recording relevant Internet information has a CAC mechanism. The QoS server end 150 can be located in a remote-end LAN, such as an internal LAN of a telecommunication service provider or an internal LAN of a business.

The first access point 110 is controlled by the QoS server end 150. If the second access point 120 is also controlled by the QoS server end 150, the first access point 110 and the second access point 120 will respectively feedback the network communication quality of the first LAN 160 and the second LAN 170 to the QoS server end 150 when the first caller 130 queries the QoS server end 150. If the second access point 120 is not controlled by the QoS server end 150, the QoS server end 150 probes the network communication quality of the second LAN 170.

If the network communication quality of the first LAN 160 and the second LAN 170 is above the pre-determined quality, then the method proceeds to step 220, the first caller 130 transmits a simulation packet to the first callee 140 for probing the transmission quality of the end-to-end transmission path P1 of the first caller 130 and the first callee 140. The data structure of the simulation packets is identical to that of the voice packet. In the present embodiment of the invention, despite the voice packets have the first transmission priority, the transmission bandwidth may still be too narrow. When there are more and more voice packets having the first transmission priority, the QoS will deteriorate. Thus, in step 220, the properties of the voice packets in the end-to-end transmission path P1 such as delay, delay jitter and packet loss rate are obtained by way of simulation according to the same type of transmission media, and the transmission quality of the end-to-end transmission path P1 is further probed and obtained.

Then, the method proceeds to step 230, whether the corresponding QoS parameter is larger than a threshold value is determined according to the transmission quality. That the QoS parameter is larger than the threshold value implies that the communication between the first caller 130 and the first callee 140 once established will conform to the requirements of the QoS. Therefore, in step 240, the first caller 130 invites the first callee 140 to communicate via the Internet 180. Afterwards, the first callee 140 rings the first caller 130, and the first caller 130 transmits an acknowledgement signal (ACK) to the first callee 140 to establish communication. If the QoS parameter is smaller than the threshold value, the QoS server end 150 will control the first access point 110 to reject the communication request of the first caller 130.

Next, the method proceeds to step 250, when the first caller 130 communicates with the first callee 140, the first caller 130 transmits a simulation packet to the first callee 140 every one fixed time interval to keep monitoring the transmission quality of the end-to-end transmission path P1. The fixed time interval is determined according to user settings, and no further restriction is applied. Then, the method proceeds to step 260, the first caller 130 feedbacks the obtained transmission quality to the QoS server end 150. After communication is established, step 250 and step 260 are substantially executed to keep monitoring the transmission quality of the end-to-end transmission path P1 by way of simulation packet. If the transmission quality is found to be at the edge of failing to conform to the requirements of the QoS, the QoS server end 150 will restrict the number of LAN users by controlling the access points.

Then, the method proceeds to step 270, if the QoS parameter corresponding to the transmission quality is smaller than the threshold value, the QoS server end 150 controls the first access point 110, such that the first request end (not illustrated) located in the first LAN 160 cannot access the Internet 180 via the first access point 110. The first request end is, for example, the second caller, who would like to communicate with the second callee via the Internet. The first request end would also like to transmit the packets of other types via the Internet.

Besides, if the second access point 140 is also controlled by the QoS server end 150, and the QoS parameter corresponding to the transmission quality is smaller than the threshold value, the QoS server end 150 controls the second access point 120, such that the second request end (not illustrated) located in the second LAN 170 cannot access the Internet 180 via the second access point 120.

In step 270, the QoS server end 150 controlling the first LAN 160 substantially controls the first access point 110 to restrict the number of the users of the first LAN 160 to avoid the QoS being deteriorated when too many users are admitted. Thus, the QoS for current users is maintained.

According to the Internet communication method and system disclosed in the above embodiment of the invention, the voice packets are set to have a first transmission priority, and will be transmitted with priority before packets of other types are transmitted. Thus, the transmission of the voice packets will not be affected by packets of other types. Besides, whether the LAN is capable of providing the minimum QoS required for transmitting the voice packets is determined by way of monitoring the transmission quality of an end-to-end transmission path in real time. If the QoS cannot conform to the requirement of the user, the QoS server end restricts the number of LAN users by a CAC mechanism to avoid more users entering the LAN and avoid the transmission quality of the end-to-end transmission path being deteriorated, such that the QoS of Internet communication is assured.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An Internet communication method applied to a first caller and a first callee, wherein the first caller is located in a first LAN and accesses the Internet via a first access point (AP), the first callee is located in a second LAN and accesses the Internet via a second access point, the Internet communication method comprises the following steps of:
setting the first caller and the first access point, such that the voice packets of the first caller have a first transmission priority;
querying a quality of service (QoS) server end regarding whether the network communication quality of the first LAN and the second LAN is above a pre-determined quality by the first caller via the Internet;
transmitting a simulation packet to the first callee by the first caller for probing a transmission quality of an end-to-end transmission path of the first caller and the first callee if the network communication quality of the first LAN and the second LAN is above the pre-determined quality;
determining whether a corresponding QoS parameter is larger than a threshold value according to the transmission quality; and
inviting the first callee to communicate by the first caller via the Internet when the QoS parameter is larger than the threshold value.

2. The Internet communication method according to claim 1, wherein the simulation packet is identical to the voice packets.

3. The Internet communication method according to claim 1, further comprising the following steps of:
setting a media access control (MAC) layer of the first caller, such that the voice packets have the first transmission priority with respect to the first caller; and
setting the first access point by the first caller via a back-end program, such that the voice packets have the first transmission priority with respect to the first access point.

4. The Internet communication method according to claim 1, further comprising the following steps of:
ringing the first caller by the first callee; and
transmitting an acknowledgement (ACK) signal to the first callee by the first caller to establish communication.

5. The Internet communication method according to claim 4, further comprising the following steps of:
transmitting the simulation packet to the first callee by the first caller every one fixed time interval to keep monitoring the transmission quality of the end-to-end transmission path when the first caller communicates with the first callee; and
feedbacking the obtained transmission quality to the QoS server end by the first caller.

6. The Internet communication method according to claim 5, wherein the QoS server end has a call admission control (CAC) mechanism, the first access point is controlled by the QoS server end, and the Internet communication method further comprises the following steps of: controlling the first access point by the QoS server end if the QoS parameter corresponding to the transmission quality is smaller than the threshold value, such that a first request end located in the first LAN cannot access the Internet via the first access point.

7. The Internet communication method according to claim 6, wherein the first request end is a second caller.

8. The Internet communication method according to claim 6, wherein the second access point is controlled by the QoS server end, and the Internet communication method further comprises the following steps of:
controlling the second access point by the QoS server end if the QoS parameter corresponding to the transmission quality is smaller than the threshold value, such that a second request end located in the second LAN cannot access the Internet via the second access point.

9. The Internet communication method according to claim 1, wherein the QoS server end is located in the first LAN.

10. The Internet communication method according to claim 1, wherein the QoS server end is located in a remote-end LAN.

11. The Internet communication method according to claim 1, wherein the first LAN is a wireless LAN.

12. The Internet communication method according to claim 1, wherein the first caller is a probing-based VoIP.

13. An Internet communication system, comprising:
a first access point and a second access point respectively located in a first LAN and a second LAN;
a first caller having a probing-based mechanism, wherein the first caller accesses the Internet via the first access point and has voice packets with a first transmission priority; and
a first callee for accessing the Internet via the second access point;
wherein the first caller transmits a simulation packet to the first callee for probing a transmission quality of an end-to-end transmission path of the first caller and the first callee to determine whether to invite the first callee to communicate via the Internet.

14. The Internet communication system according to claim 13, wherein the simulation packet is identical to the voice packets.

15. The Internet communication system according to claim 13, further comprising a QoS server end, wherein the first caller, via the Internet, queries the QoS server end regarding whether the network communication quality of the first LAN and the second LAN is above a pre-determined quality, and the first caller transmits the simulation packets if the network communication quality of the first LAN and the second LAN is above the pre-determined quality.

16. The Internet communication system according to claim 15, wherein the first caller determines whether a corresponding QoS parameter is larger than a threshold value according to the transmission quality, and the first caller invites the first callee to communicate via the Internet if the QoS parameter is larger than the threshold value.

17. The Internet communication system according to claim 16, wherein the first callee rings the first caller, and then the first caller transmits an acknowledgement signal to the first callee to establish communication.

18. The Internet communication system according to claim 17, wherein when the first caller communicates with the first callee, the first caller transmits the simulation packet to the first callee every one fixed time interval to keep monitoring the transmission quality of the end-to-end transmission path, and the first caller feedbacks the obtained transmission quality to the QoS server end.

19. The Internet communication system according to claim 18, wherein the QoS server end has a CAC mechanism, the first access point is controlled by the QoS server end, and the QoS server end controls the first access point if the QoS parameter corresponding to the transmission quality is smaller than the threshold value, such that a first request end located in the first LAN cannot access the Internet via the first access point.

20. The Internet communication system according to claim 19, wherein the first request end is a second caller.

21. The Internet communication system according to claim 19, wherein the second access point is controlled by the QoS server end, and the QoS server end controls the second access point if the QoS parameter corresponding to the transmission quality is smaller than the threshold value, such that a second request end located in the second LAN cannot access the Internet via the second access point.

22. The Internet communication system according to claim 15, wherein the QoS server end is located in the first LAN.

23. The Internet communication system according to claim 15, wherein the QoS server end is located in a remote-end LAN.

24. The Internet communication system according to claim 13, wherein the first LAN is a wireless LAN.

25. The Internet communication system according to claim 13, wherein the first caller is a probing-based VoIP.

26. The Internet communication system according to claim 13, wherein the MAC layer of the first caller is set such that the voice packets have the first transmission priority with respect to the first caller, and the first caller sets the first access point via a back-end program, such that the voice packets have the first transmission priority with respect to the first access point.
